(19) United States
(12) Patent Application Publication
(10) Pub. No.: US 2007/0263540 A1
(43) Pub. Date: Nov. 15, 2007

(54) Method and Device for the Automatic Readjustment of Limits for Access Controls Used to Restrict Traffic in a Communication Network

(76) Inventors: Joachim Charzinski, Munchen (DE); Karl Schrodi, Geretsried (DE); Uwe Walter, Weingarten (DE); Christian Winkler, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/791,809

(22) PCT Filed: Nov. 23, 2005
(86) PCT No.: PCT/EP05/56175

§ 371 Date: May 29, 2007

(30) Foreign Application Priority Data
Nov. 29, 2004 (DE) 10 2004 057 496.0

(51) Int. Cl. G08C 15/00

(52) U.S. Cl. 370/232

(57) ABSTRACT

There is described a method and a configuration system for the automatic readjustment of limits for access controls used to restrict the traffic in a communication network formed by links, said communication network comprising control bodies for performing the access controls. The readjustment of limits for access controls is triggered by an event. A traffic matrix of the network is recorded in the configuration system of the communication network, and a recalculation of link weights is carried out by the configuration system by means of a traffic matrix. New limits are determined limits are respectively transmitted to associated control bodies for performing the access restriction and are activated for access controls. The method enables the limits for the access controls to be automatically monitored.

### CROSS REFERENCE TO RELATED APPLICATIONS

This application is the US National Stage of International Application No. PCT/EP2005/056175, filed Nov. 23, 2005 and claims the benefit thereof. The International Application claims the benefits of German application No. 10 2004 057 496.0 DE filed Nov. 29, 2004, both of the applications are incorporated by reference herein in their entirety.

### FIELD OF INVENTION

The invention relates to a method and a configuration system for the automatic readjustment of limits for access controls used to restrict the traffic in a communication network formed by links, said communication network comprising control bodies for implementing the access restrictions.

### BACKGROUND OF INVENTION

One of the most important developments in the field of networks is the further development of data networks for the transmission of real-time traffic, i.e. voice, video information and audio information. To make a data network have real-time capability, mechanisms must be provided that ensure compliance with so-called service quality features, such as—for example—the transmission duration, the so-called jitter, and the packet loss rate. In a network with real-time capability it is necessary to prevent situations arising in which the said service quality features can no longer be guaranteed. The drawback of conventional data networks is that overload situations can occur, potentially resulting in excessively long packet runtimes or even loss of packets. Thus data networks or packet networks with real-time capability—conventional data networks are generally based on the transmission of IP packets, such as the Internet, for example—operate with traffic restriction, at least for real-time traffic, in order to make the necessary quality of service available for the real-time traffic. Traffic restriction is based mainly on access controls on the network edge, is initiated in the course of the traffic to be transmitted, and is authorized or rejected depending on available bandwidth.

When setting up access controls it is necessary, firstly, for an adequate quality of service to be guaranteed, and, secondly, it is in the network operator's interests to transfer as much traffic as possible, in order to achieve the highest possible income. When selecting limits, therefore, it is necessary to reach a compromise that permits the transmission of as much traffic as possible without thereby impairing the quality of service.

In data networks, operators are also able to optimize the transmission and/or distribution of traffic in their networks by defining so-called link weights. In larger networks, setting limits for access controls and link weights represents a considerable outlay. If, in addition, further parameters are to be predefinable on the operator side, in order—for example—to comply with economic agreements, and the settings are to be traceable when traffic conditions change, the operator is confronted with configuration tasks involving considerable cost and complexity.

### SUMMARY OF INVENTION

An object of the invention is to optimize the tracing of limits for access controls in a communication network.

The object is achieved by the items described in the independent claims.

It is proposed that the limits for access controls used to restrict the traffic in a communication network formed by links are to be automatically set or traced. In the following it is assumed that this communication network contains control bodies by means of which access controls may be implemented. A configuration system is disposed in the network for the automatic configuration of limits. The readjustment of limits (some of the limits used for access controls, or all limits) for the access controls is triggered by an event. The traffic matrix and the link weight of the network are recorded in the configuration system of the communication network. These may be determined as a response to the triggering of the readjustment and then recorded or even regularly or periodically recalculated and delivered to the configuration system. It is also possible for network parameters to be adjusted or set by the operator. For example, the operator could configure a new traffic matrix and this event could trigger a readjustment. A recalculation of link weights is carried out by means of the traffic matrix, and new limits for the access controls are determined on the basis of the recalculated link weights. These limits are respectively transmitted to associated control bodies for performing the access restriction. The transmitted limits are then activated for the access controls by means of the calculated limits. Activation may be effected by the configuration system, for example, by means of an activation message. Therefore, for the purposes of further development, the limits that are accompanied by a reduction in the corresponding bandwidth available for reservations are activated first. If these limits are complied with, then this is signaled to the configuration system, which then activates the other limits. In addition to the recalculated limits, the recalculated link weights can likewise be transmitted to routers in the network and activated there for routing within the network.

The invention allows the automatic calculation and configuration of operating parameters, such as—for example—limits for access controls und link weights. This automatic calculation configuration of operating parameters saves the operator from having to use external optimization programs, converting parameters between different formats, and manually keying in the parameters, and therefore reduces the costs of implementing access controls for traffic restriction or traffic engineering in packet networks. The automatic tracing of parameters brings the additional advantage that the network operator does not have to deal with more minor and more frequent failures in the network control center.

An event for triggering the readjustment of limits may, for example, be a failure in one or more network elements (links or nodes) or a change in the topology of the network, a new input of network parameters (e.g. framework for new operator specifications) or the expiry of a time limit for which a recalculation is provided in the course of a regular tracing operation. If the event in the failure comprises at least one network element, it is possible to provide that a recalculation of the limits is not carried out until expiry of a time limit. The reason for this is that, in current networks, short-term failures frequently occur in which a response on the timescale of readjusting the limits is not necessary. It is also possible, after a network failure, for the network to be blocked for new traffic until new limits have been determined and activated for the access controls. Alternatively, limits may be defined from the outset such that any redundant bandwidth is used for failure situations, so that a fault or failure does not impair normal operation. In this case a recalculation of limits is useful since this recalculation then results in redundant bandwidth being available again for the interception of fault incidents.

The inventive configuration system is designed for the transmission of recalculated limits for access controls to control bodies. It may, in addition, be adapted for the activation of the transmitted limits in the control bodies. If the recalculated link weights are to be transmitted to routers and activated there, the configuration system may also be configured for these purposes.

The configuration system may be implemented centrally or in distributed form. A central implementation would, for example, be on a control server in the network management system or in a service control unit. The central implementations would, for example, be in routers or in access control elements; in the latter case the configuration system would be implemented on the same hardware platform as the associated control body. The exchange of information would then take place over internal interfaces.

### BRIEF DESCRIPTION OF THE DRAWINGS

The invention is described below in the context of an exemplary embodiment with the help of diagrams. The term “budget” is used for the bandwidth available for transporting traffic as a result of the setting of limits for the access controls.

In the diagrams,

FIG. 1 shows an inventive configuration system with input and output variables.

FIG. 2 shows a response to the failure of a link according to the inventive method.

### DETAILED DESCRIPTION OF INVENTION

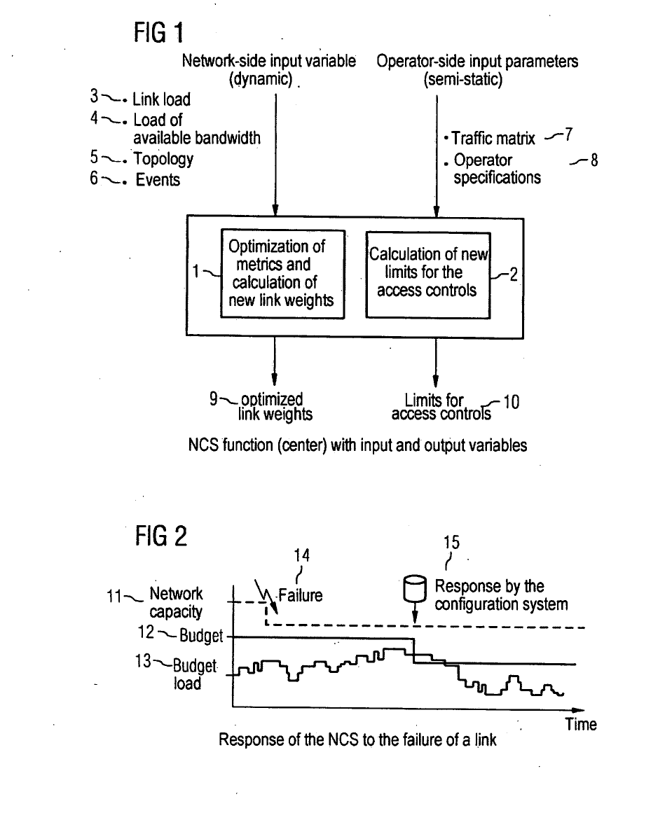

FIG. 1 schematically illustrates a configuration system according to the invention. In this system, modules are assigned for the following functions:
1: Optimization of metrics and calculation of new link weights (Link Metric Optimization).
2: Calculation of new limits for access controls (NAC Budget Computation).

Input variables for the system on the network side are the link load 3, the load of available bandwidth or the bandwidth still available within the individual limits (budget usage) 4, the network topology 5 and events 6, such as—for example—network failures, which may lead to a recalculation of limits. On the operator side, it is possible to specify a traffic matrix 7. It is, however, also feasible for a traffic matrix to be determined by automated measurements at regular intervals and to be forwarded to the configuration system. Operators may also specify rules or marginal conditions (operator policies) 8, which are necessitated by economic considerations, e.g. the preference of traffic from specific customers or additional prioritizations. Thus the operator may—for example—configure a threshold for the number of link failures, in which the budgets are still to be calculated preventively, so that—in the event of further failures—the QoS (QoS: Quality of Service) undertakings or the promised quality of service on the authorized reservations may continue to be complied with. Every preventive reduction in the budget naturally increases the blocking frequency and thus reduces the income of the network operator, while, on the other hand, they offer protection against infringement of QoS undertakings.

As output variables, the configuration system delivers optimized link weights (optimized link metrics) 9 and the limits (budgets with resilience) 10 for the access controls NAC (NAC: network access control), which may be defined such that redundant bandwidth for the interception of failures is provided for the failure of network elements.

A further protocol may be used for the activation of limits or budgets, in order to achieve a consistent budget adjustment. Initially only the budget reductions are activated by the budget adjustments. The access control bodies (NACs) notify the configuration system (e.g. Network Control Server NCS) as soon as the reserved budget in each case is within the redefined budget. When all NACs for all changed budgets have signaled to the NCS that the budgets are now complied with, the NCS can increase the remaining budget (to be increased).

During network operation, link and budget loads as well as topology changes (failures, restarts, network expansions) and other events are observed, and new budgets or link cost metrics are calculated if necessary. The response to failures is described in greater detail below. The processing of the load metrics data is the object of a separate application.

FIG. 2 schematically shows the sequence of the available network capacity 11, the available budget 12 and the utilization of the budget over time (budget utilization) 13. The budgets 12 are to be calculated such that the permitted traffic can still be transported even after the failure 14 of any link in the network, with the specified QoS statements or with the promised quality of service. If, then, such a failure 14 actually occurs (symbolized by the arrow in FIG. 2), then nothing further needs to happen other than the reestablishment of accessibility in the network by means of a rapid failure detection and a correspondingly fast rerouting.

In order to ensure, even if further link failures occur, that the quality of service (QoS) can still be complied with, the configuration system (NCS: network control server) 15 will nevertheless adapt the budgets to the new topology currently applicable (NCS reaction). FIG. 2 shows that, after this adjustment, more budget 12 can initially be reserved than is actually available. While this is the case, all new reservation requests on the budgets concerned are blocked. Due to the natural fluctuation in reservations this transient or temporary status is released again after some time, if enough reservations have been ended. From this point on the resource administration functions normally again, and new reservations are permitted if they still fit into the budget concerned. The blocking capability, i.e. the average rate for rejection of reservation requests, is naturally somewhat greater than before due to the reduced budget, but this is the natural consequence of the fault in the failed network resources.

When a link that has failed returns to operation, the budgets can be recalculated gain accordingly and the new values can be configured again in the configuration system or NAC components.

1-11. (canceled)

12. A method for an automatic readjustment of limits for access controls used to restrict traffic in a communication network formed by links, comprising:
providing control bodies to perform the access controls;
readjusting the limits triggered by an event;
recording a traffic matrix of the network in a configuration system of the communication network;
recalculating link weights by the configuration system based upon the traffic matrix;
determining new limits based upon the recalculated link weights;
transmitting the determined limits to associated control bodies to perform the access restriction; and
activating the transmitted limits.

13. The method as claimed in claim 12, wherein the recalculated link weights are transmitted to network routers and activated there for routing within the network.

14. The method as claimed in claim 12, wherein the event is caused by a failure of one or more network elements.

15. The method as claimed in claim 12, wherein the event is caused by a new input of network parameters.

16. The method as claimed in claim 12, wherein the event is caused by an expiry of a predefined time limit in the course of a regular tracing operation.

17. The method as claimed in claim 12, wherein the event is a failure of at least one network element, and wherein the limits are readjusted after an expiry of a time limit, when the failure still exists upon expiry of the time limit.

18. The method as claimed in claim 12, wherein the event is a failure of at least one network element, and wherein new traffic is not permitted until new limits are determined and activated for the access controls.

19. The method as claimed in claim 12, wherein new limits are activated to reduce bandwidth available for the access controls, wherein a compliance with the limits is signaled to the configuration system, and wherein remaining limits are activated.

20. The method as claimed in claim 12, wherein the configuration system transmits recalculated limits for access controls to control bodies.

21. A configuration system in a communication network for an automatic readjustment of limits for access controls used to restrict traffic in a communication network formed by links, comprising:
control bodies to perform the access controls, wherein the limits triggered by an event are readjusted, and wherein a traffic matrix of the network is recorded in the configuration system; and
recalculated limits determined based upon recalculated link weights, wherein the recalculated link weights are recalculated via the configuration system based upon the traffic matrix and wherein the determined recalculated limits for access controls are transmitted to control bodies.

22. The configuration system as claimed in claim 21, wherein the configuration system activates limits for the access controls.

23. The configuration system as claimed in claim 21, wherein the configuration system transmits recalculated link weights to routers.

24. The configuration system as claimed in claim 23, wherein the configuration system activates recalculated link weights.

25. The configuration system as claimed in claim 21, wherein the configuration system is implemented on a control server.

26. The configuration system as claimed in claim 21, wherein the configuration system is implemented in the network management system.

27. The configuration system as claimed in claim 21, wherein the configuration system is implemented in a service control unit.

28. The configuration system as claimed in claim 21, wherein the configuration system is implemented in routers.

29. The configuration system as claimed in claim 21, wherein the configuration system is implemented in access control elements.
